(19) United States
(12) Patent Application Publication
(10) Pub. No.: US 2008/0318192 A1
(43) Pub. Date: Dec. 25, 2008

(54) Training Apparatus

(76) Inventor: Mark Jones, Chester (GB)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 12/063,972

(22) PCT Filed: Aug. 16, 2006
(86) PCT No.: PCT/GB06/03041

§ 371 Date: Jul. 23, 2008

(30) Foreign Application Priority Data
Aug. 18, 2005 (GB) 0516905.7

(51) Int. Cl. G09B 5/00

(52) U.S. Cl. 434/247

(57) ABSTRACT

The invention relates to an apparatus, for training a user to develop one or more actions which may facilitate improved compliance to an event by the user. It comprises: • a screen for displaying information relating to the event to the user; and • a user interface, enabling the user to control a program which demonstrates the one or more actions to the user in the context of the event. The apparatus is programmed to demonstrate the one or more actions through one or more characters and the user is able to observe the one or more actions and optionally control the event outcome, by being able to control the one or more, actions of the one or more characters. Preferably each different action is demonstrated by a different character such that the user associates a specific action with a specific character and can thus be, prompted in an event situation to act in a given way, by reference to the specific character.

The present invention relates to an apparatus for facilitating improved compliance to an event by a user. More particularly, the apparatus is a computer or games or teaching console or media-telephone having a screen and a user interface which may be programmed to demonstrate, for example, a medical procedure and comprises one or more characters which may be manipulated by the user to teach the user behavioural skills.

### BACKGROUND OF THE INVENTION

Every year, children go to hospital and undergo medical procedures that can be both painful and distressing. Cognitive behavioural techniques (CBT) have been shown to reduce pain and distress associated with medical procedures. However, CBT is often used incorrectly and inconsistently due to a lack of staff, time, equipment and inadequate training.

Heimber, R. G., Dodge, C. S. & Becker, Rt. E. (1987). “Social phobia.” in L. Michelson & M. Ascher (eds), “Anxiety and Stress Disorders: Cognitive-Behavioural Assessment and Treatment.” New York: Guildford Press define CBT as comprising the following:
a) Providing the child with a cognitive behavioural explanation of the problem;
b) Through the use of structured exercise the child is taught to identify, analyse and question problematic cognitions;
c) During the teaching stage the child is exposed to simulations of anxiety-provoking situations;
d) Using cognitive restructuring procedures the child is taught to control their maladaptive thinking before, during and after simulated exposures,
e) The child is given “test” assignments for in vivo exposure to situations confronted during the exposure situations;
f) The child is taught self-administered techniques to help with the problem situation.

CBT uses general information, motivational instruction and real world practice skills to promote positive coping in stressful situations. Jay, S. M., Ozolins, M., Elliott, C. H., Olson, R. A., Pruitt, S. D. (1985). “Behavioural management of children's distress during painful medical procedures.” Behavioural Research Therapy, (23), pp. 512-530. Specific CBT strategies include:
Information;
Attention diversion;
Relaxation;
Reinforcement;
Imagery;
Behavioural rehearsal;
Filmed modelling of co-operative behaviour;
Hypnosis and
Positive self-talk.

There is a lot of information on “old media” (e.g. Books and film) and its use for children in hospital but little on “computer based media”. Computer based media has however been used for distraction therapy (though not teaching distraction) and computer assisted instruction.

Thus, for example, computer games have been used in hospitals for children as a highly effective means to distract them. However, the computer games are not in themselves used to teach the skill of self distraction.

Computer-based media has also been used to provide computer assisted instruction (CAI) by text and low level graphics. By making the CAI media more like a game it has been shown that it can influence attitudes, develop skills and help in decision making (Billings, D. M. (1986). “Advantages and disadvantages of computer-assisted instruction.” Dimensions of Critical Care Nursing. (5), pp 356-62.)

A problem with CAI media is that the patient who uses it must be literate to understand it and be able to use a computer.

However, pre-school children are not literate.

Brown, S. J., Lieberman, D. A., Gemeny, B. A., Fan, Y. C., Wilson, D. M., & Pasta, D. J. (1997). “Educational video game for juvenile diabetes: Results of a controlled trial”. Medical Informatics 22(1), pp 77-89 describes an interactive adventure video game (Packy & Marion) that uses experiential teaming to improve self-management of diabetic children and adolescents. The game was evaluated in a six-month controlled trial. In the game, youngsters play the role of a character that has diabetes; and manage their character's blood glucose monitoring, insulin use, and food selections for four simulated days, while the character tries to save a diabetes summer camp from marauding rats and mice. Keeping their character's blood glucose within the normal range, through appropriate insulin and food, helps players win the game.

Study participants were young people ages 8 to 16 who were outpatients of diabetes clinics at Stanford University Medical Center and at a Kaiser Permanente clinic.

In contrast to the present invention the game does not use a plurality of characters each of which is associated with a unique/specific behavioural action.

Lieberman, D. A. (2001). Management of chronic paediatric diseases with interactive health games: Theory and research findings, Journal of Ambulatory Care Management, 24(1), pp 26-38. describes the results of clinical trials, in which children and adolescents learned about health, increased their health-related self-efficacy, improved their self-care, and reduced their emergency and urgent care clinical visits after playing health education video games aimed at asthma self-management, diabetes self-management, and smoking prevention. The video games were designed on the basis of theories of learning and behaviour change, including social cognitive theory, successful health promotion strategies and theories, and validated principles of interactive media instructional design, ASTHMA: Three studies of an asthma self-management video game, called Bronkie the Bronchiasaurus, found improvements in attitudes, behaviours, and outcomes. The first, a clinic-based pre-test-post-test study of 50 asthmatic children, found that their asthma-related self-concepts, social support, knowledge, and self-care behaviours improved within a month after they first played the asthma video game. The second study was a randomized experiment in which playing the asthma video game for 30 minutes was contrasted with watching a 30-minute videotape about asthma self-care. Children who played the video game experienced a gain in asthma-related self-efficacy while those who watched the videotape experienced a drop in self-efficacy, most likely because the videotape presented a great deal of “how-to” information but offered no opportunity to rehearse those skills. The third asthma study involved observation of children who were hospitalized with asthma emergencies and had access to the asthma video game in the hospital, Observers noted that the children played the asthma video game extensively and usually played it with other hospitalized children; the game served as a springboard for discussion with peers and caregivers about asthma; and parents were pleased that their children had access to the game.

DIABEThS: A diabetes self-management video game, called Packy & Marion, improved children's self-efficacy and social support, and reduced diabetes-related emergency and urgent care visits by 77 percent, when diabetic youngsters had the game at home for six months; there was no reduction in clinical visits in a control group of diabetic youngsters who took home an entertainment video game that had no diabetes-related content.

SMOKING PREVENTION: A pre-test-post-test study of a smoking prevention video game, called Rex Ronan, found it was effective in teaching pre-adolescents about specific ways tobacco can harm the body, and this strengthened their anti-smoking attitudes and their resolve not to start smoking.

None of these games teach different behavioural skills through the use of a specific character and all were aimed at children who would be expected to read.

A further document, “Personal investigator. A therapeutic 3D game for adolescent psychotherapy”, International Journal of interactive Technology and Smart education, Vol 2, Issue 2, May 2005 describes an interactive computer game designed to be played by teenagers suffering from depression and anxiety. It's focus is to improve relationships between therapists and users based on combining goal orientated gaining with a model of goal orientated therapy. Whilst the game employs a number of characters representative of “real life”, it does not use the unique characters to teach the user a given coping skill in a manner whereby the character act as a mnemonic for the coping skill being taught by the actions of the character.

### TECHNICAL PROBLEM TO BE SOLVED

A current limitation to cognitive therapies is the use of the Piaget's cognitive development stages model. This model claim there are limits to children understanding of concepts depending on their age, although recent research suggests that the children might be more capable of understanding these issues than first considered. For the information to be understood by the child alternative ways of explaining issues need to be used, for example, pictures instead of words.

With more children visiting hospitals to have medical procedure, and a lack of qualified staff or available contact time for therapists, a computer-based system for delivering CBT would be advantageous.

A first object of the present invention was to develop an apparatus and method of delivering cognitive behavioural therapy effectively and cheaply, particularly to young particularly pre-school) children.

This object has been met by the programmed apparatus of the invention. Through the use of a program in which a single specific behavioural technique is taught by a single character the user is able to learn to associate the technique being taught with the particular character. Thus in a “real” event situation it is possible to obtain compliance by asking the user to “do or act as the specific character did”.

Further objects of the invention needed to be addressed to provide a programmed apparatus suitable for use by the target market, primarily children. These are set out further in the general description.

In particular, the design of screen layout, interactivity and instructional issues all provided significant challenges for the intended user group.

### BRIEF SUMMARY OF THE INVENTION

According to a first aspect of the present invention there is provided an apparatus, for training a user to develop coping-skills which may facilitate improved compliance to an event by the user, comprising:
a screen for displaying information relating to the event to the user;
a user interface, enabling the user to operate a program which demonstrates the coping-skills to the user in the context of the event,
   wherein the apparatus is programmed to display a plurality of visually different characters that can be observed and interacted with by the user;
   each character being unique and programmed to exclusively perform an act or acts that will teach the user a specific coping skill to the exclusion of a different coping skill, whereby through use, the user is conditioned to relate a particular coping skill taught by a given character to that character such that in an event situation the user can be prompted to perform a specific coping skill by reference to the actions of an individual character (i.e. the character act as a mnemonic for the coping skill being taught by the actions of the character).

In other words the user can be requested to perform a particular coping skill not by asking them to, for example, . . . breath in, breath out etc BUT instead by asking them to, for example, do what a given character did.

Thus, it is essential that each character is programmed to exclusively perform an act or acts relating to a specific skill such that the user is conditioned to relate that skill to the character i.e. the character becomes a mnemonic for the coping skill it teaches.

In one embodiment the coping skills taught are selected from the group consisting of breathing, relaxation and distraction.

In a further embodiment the invention takes the form of the programmed operating instructions. This may take the form of a DVD, or other known means for transferring the data to an apparatus for it's subsequent operation. Alternatively the programme may be downloaded to a suitable apparatus via the internet or through telephonic lines.

Preferably each different coping-skill is demonstrated by a different character such that the user is trained to associate a specific coping-skill with a specific character and can thus be prompted in an event situation to act in a given way, by reference to the specific character.

One coping technique taught is the act of breathing. Thus, the character is caused to “breathe in” and “breathe out” through interaction by the user at the interface.

The functional interaction by the user sends a signal to the apparatus such that the user is able to control the action of the character and thus learn the behaviour through such interaction and visual stimulation. Thus, the user interface provides the means through which the technical effect of altering the visual characters appearance to teach a behaviour is learnt such that the user can apply the teaching in a “real” scenario to, for example, obtain medical relief e.g. reduced pain/stress.

In a preferred embodiment the character is something with which a child can readily relate to the objective. Thus, for breathing the character may be a fish, and the exercise may result in the character “deflating” and “inflating” or bubbles being “blown”.

Alternatively the character may be an elephant whose trunk may be used to demonstrate the act of breathing.

Another coping technique taught is the act of the act of relaxation. Thus, the character is caused to “tense” and “relax” through interaction by the user at the interface. In one embodiment the character is a dog.

Another coping technique taught is the act of distraction. Thus, the character is caused to “look away” through interaction by the user at the interface. In one embodiment the character is a Teddy Alternatively the character could be a cat that is distracted by, for example, playing with a ball of string.

Preferably the apparatus further provides one or more of:
information on the event,
a simulation of the event typically, but not essentially a medical procedure e.g. venepuncture, and
a reward (following completion of the event).

In a preferred embodiment the event is a medical procedure.

Preferably the apparatus is used in a method of delivering a pre-treatment to a medical procedure, such as, for example, a veneprocedure.

The apparatus has been designed particularly for use with a child or person with learning difficulties.

The invention also provides a method of facilitating improved compliance with an event by a user by delivering CBT using an apparatus of the invention.

### BRIEF DESCRIPTION OF THE FIGURES

The invention will be further described, by way of example only, with reference to the following embodiments and examples in which:

FIG. 1 illustrates a schematic of an apparatus of the invention;

FIG. 2 is the main display screen from a programmed computer assisted cognitive behavioural therapy apparatus displaying the “butterfly game”;

FIGS. 3a and 3b illustrates a character in positions illustrating the technique of: “distraction”;

FIGS. 4a and 4b illustrates a character in positions illustrating the technique of: “breathing”; 4a breath in and 4b breath out; and

FIG. 5a (relax) and 5b (tense) illustrates a character in positions illustrating the technique of: “relaxation”.

### DETAILED DESCRIPTION OF THE INVENTION

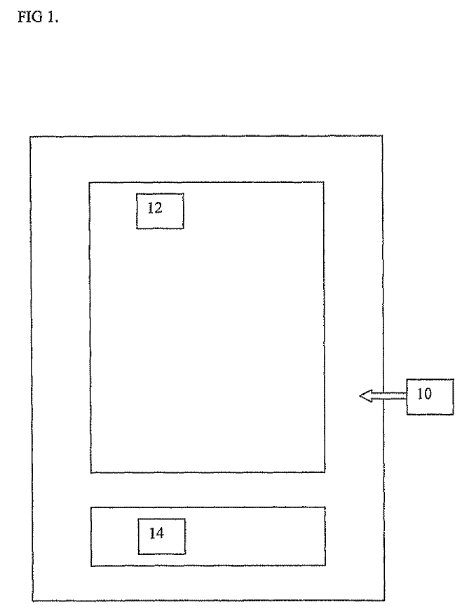

Referring to FIG. 1 the apparatus (10) is a hand held console comprising a screen (12) and a user interface (14).

It will however be apparent to a skilled person that the apparatus could take the form of a television, computer, telephone or the like having a screen, and an integral or remote user interface together with a means (not shown) for running a program (also not shown) which may be provided as hardware, software or some other medium.

Accordingly, the invention also extends to a medium e.g. a disc, CD or DVD which enables an apparatus to operate as per the programmed apparatus or method of the invention.

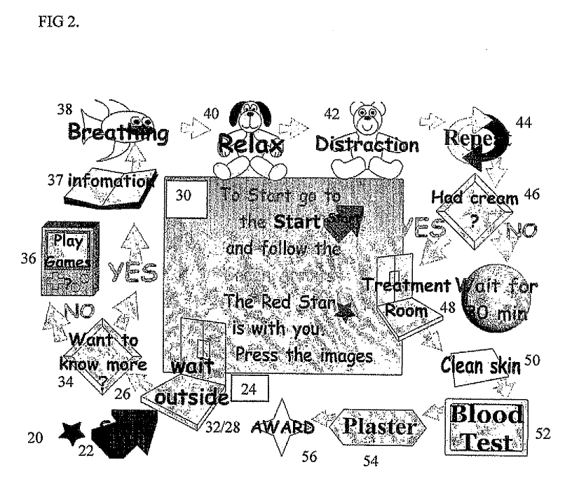

Turning to FIG. 2 there is illustrated a “screen dump” of the “board game apparatus” style lay output of one such programmed apparatus.

The screen design (20) has been specifically designed to facilitate its use by young children. Accordingly, the screen has a lay out familiar to children as it is set out like a “board game apparatus”, having a defined track (22) around its perimeter (24), with arrows (26) indicating a way of moving around the “board” from one function hereafter “square” (28) to another. Inside the perimeter squares is a central information area (30).

The screen design mimics the lay out of a hospital treatment centre and the chronological steps which the child (patient) will be exposed to when undergoing a medical procedure or event.

Thus, the child starts by “entering” the hospital adjacent the “wait outside” door (32) and is presented with two options at “want to know more” square (34).

A “no” answer takes the child to “Play games” (36) and a “yes” answer takes the child via “information” square (37) to the behavioural learning exercises (38; 40; 42). These are:
“Breathing” square (38);
“Relax” square (40) and
“Distraction” square (42).

Once the child has completed these sections they are offered the opportunity to “repeat” what they have learnt. “Repeat” square (44).

The child is then offered “hand cream” (46) equivalent to a topical anaesthetic before moving to the “treatment room” (48) where their skin is cleaned (50), and the procedure (52) e.g. blood test is undertaken. At the end of the procedure a plaster (54) and a reward (56), e.g. a sticker is obtained.

The board game screen format is a significant technical feature in as much as it is familiar to young children and encourages use as the format is familiar. It comprises a track going around the perimeter (24) of the screen and a central information/display area (30).

The key features of the programme are the “information section” accessed through square (37) and the “learning skills” sections accessed through:
square (38) “breathing section”,
square (40) “relaxation section”, and
a square (42) “distraction section”.

These are not illustrated by way of screen dumps but the contents are described briefly below:

In the information section background and detailed information on the “event” or procedure is given. Thus the user works through a number of sections learning about a given procedure. In the example given a character “Ted” has a scan so the user can get to learn about what is inside their body. As the “event” is a venepuncture procedure the information section shows Ted's “veins” in a simple graphical way (analogous to an x-ray). In a subsequent section the “veins” are examined through a magnifying glass to show “blood cells”. The user then helps a nurse to find Ted's veins. The nurse puts a tourniquet on Ted's arm and draws blood through a “butterfly needle”

From this section the user is moved to sections which teach a variety of behavioural techniques through observation, repetition, interaction and association.

In the breathing section a unique character is introduced, in this case a fish, and demonstrates to the user the technique of breathing. The character has features which make it easy to associate the character with the technique being taught. In this example the fish is a “puffer fish” and its body expands in size as it “breathes in” and reduces in size as it “breathes” out. The user is taught that controlled breathing helps the user to stay calm. It teaches techniques e.g. making a hissing sound on breathing out. The prompts I instruction may include written and I or audible instructions.

Thus, the user is asked to “breathe out” and “breathe in”, to say “relax” and use counting techniques e.g. “breathe in for a count of one, two, and breathe out for a count of one, two, now say relax”.

Additionally the user may be taught to for example “blow bubbles” when breathing out, or pretend to play a blowing instrument e.g. a trumpet. Similarly they might be taught to breathe in by pretending to suck on a straw.

The programme may be observational or may require the user to actively cause the actions.

In the “relaxation section” a further unique character is introduced, in this case a dog, which demonstrates to the user the technique of relaxation. The character has features which make it easy to associate the character with the technique being taught. In this example the dog is able to “tense” and “relax” various parts of the body, e.g. its limbs (arms and legs) and ears. The user is taught that relaxation helps the user to stay calm. The prompts/instruction may include written and/or audible instructions.

Thus the user is asked to “tense” and “relax”, various joints and scores points for doing this. They are also encouraged to try doing the same with their body.

The programme may be observational or may require the user to actively cause the actions.

In the distraction section yet another unique character is introduced, in this case Ted, who demonstrates to the user distraction techniques. The character has features which make it easy to associate the character with the technique being taught. In this example Ted is able to move his head to one side so as to look away. The user is taught other techniques e.g. doing something else, such as, listening to or reading a storey, playing a game or singing. The prompts/instruction may include written and/or audible instructions.

In the “game section” the user may for example play the part of the nurse and try to take some blood from Ted's arm. The object is to get Ted to, for example, relax or distract Ted so it is easy to put the needle into Ted's arm. It demonstrates the difficulty of trying to stick a needle into a moving arm something that would be difficult to do in reality.

The programme may be observational or may require the user to actively cause the actions.

Additional design features of importance, due to the benefits they bring, are noted below:
To assist the children's interacting and learning of the different CBT process, a novel board game metaphor (framework) was selected. Board games are a familiar toy to children and this framework lets the user plays across different parts of the board game, thereby acquiring different information and techniques.
Large graphical icon designs were used to represent the main parts of the CBT processes, with navigation arrows between them.
Rollover icons, animations and highlight were used to indicate functionality. The “functional” direction of the CBT metaphor board game was controlled by using animated characters, and animated arrows.
A main central window was used to give additional information to the user.
The navigational design for the CA-CBT was based on a mixed hierarchical structure for the information and CBT techniques e.g. the user could jump between different parts of the CA-CBT. This makes it easy for the user to move around and explore the CA-CBT. Navigational information for the CA-CBT is placed in the central instruction window. Selection of CA-CIBT tasks is by simple movement controls across the parts of the CBT metaphor board game. The user can use the cursor to navigate or by pressing the keyboard letters, this lets the user have different ways of using the CA-CUT.
Error prevention was addressed in the design of the CA-CBT by not letting the user do anything outside the possible function range, e.g. the needle cursor could not be used on anything other than the arm.
Easy reversal of actions was enabled by allowing the user of the CA-CBT to click on the bottom of the display screen, which had a video recorder control button layout.
Five basic colours were chosen to match the user's short-term memory capacity and this was also based on the order of dominance of the spectral colours: red, orange, yellow, green, and blues Familiar colour coding was also used for the video control panel at the bottom of the screen e.g. red for stop, green for go, with additional coding methods using shape for colour deficient vision.
Learning should be by understanding. The child was thus allowed to play with CA-CBT and learn from the results of their own actions, e.g. The child could not easily place a needle into a moving teddy bear's arm. The child would then learn not to move when having a needle procedure. This process would help the child learn techniques and deal with the venepuncture procedure.
The end of each technique includes a questionnaire to test what the child has learned and thus help give the child feedback. For example the “needle game” showed the child that it was important not to move around as this results in making the task of putting the needle into Ted's arm more difficult.
The metaphor of a board game for the CA-CBT helped provide the child with incremental tasks and an overall goal to complete.
The program simulates an “event” and the child gets to experience the event. Thus in the case of venepuncture the user tries to put a needle into Ted's arm. The user also tries to put a needle into a moving Ted's arm. The child then compares the two events. The learning from these two events is that it is easier to put a needle into a stationary arm.
The CA-CBT uses animation and interactivity to attract the user. The computer animation of the CA-CDT attracts the child and guides the user thought different stages of the game. Animation was used to demonstrate actions over time e.g. the needle going into the arm and blood cells being taken out.

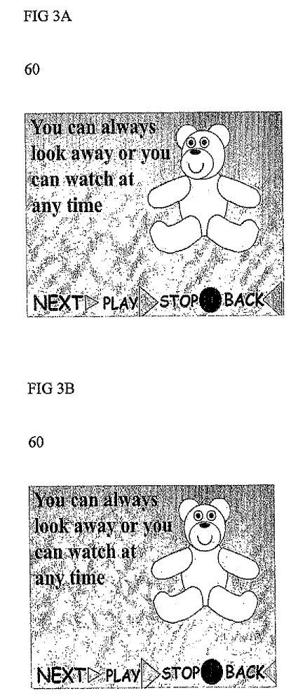

Referring to FIG. 3 there is illustrated a character (60) which is able to demonstrate the technique of “distraction”. Thus in FIG. 3a, the bear looks towards the user (or event) and in FIG. 3b, the bear looks away from the user (or event).

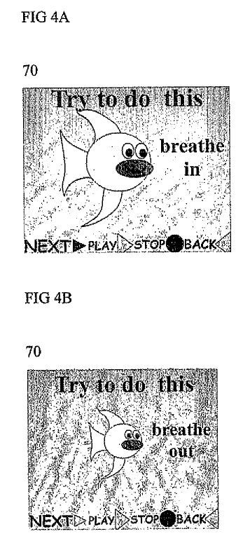

Referring to FIG. 4 there is illustrated a character (70) which is able to demonstrate the technique of “breathing”. Thus in FIG. 4a, the fish is “breathing in” and in FIG. 4b, the fish is “breathing out”. This action may be enhanced by an additional action e.g. by the evolution of bubbles

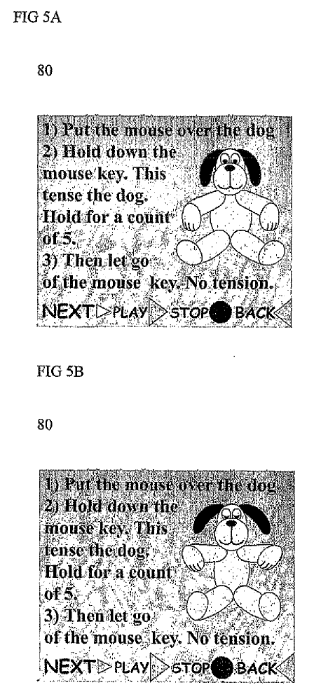

Referring to FIG. 5 there is illustrated a character (80) which is able to demonstrate the technique of “relaxation”. Thus in FIG. 5a, the dog is “tense” (limbs or other body part e.g. ears rigid) whereas in FIG. 5b, the dog is “relaxed” (limbs floppy or other body part e.g. ears floppy).

That the invention provides a valuable tool in child welfare/health and may provide tangible benefits in health care e.g. time and cost savings is illustrated with reference to its trial in a clinical study.

### Clinical Study

The programmed apparatus of the present invention has been the subject of a pilot clinical study to determine it's effectiveness in reducing pain and distress caused to children undergoing venepuncture procedures. It will be apparent that the principles described can be used with other medical and non medical procedures.

A group of 11 children aged 6-12 were subjected to cognitive behavioural therapy (CBT) using the apparatus of the invention.

Each child was able to
Obtain information about the medical procedure they were to undertake; and
Play games which educated them in the techniques which were aimed at teaching them specific coping procedures e.g.
   Breathing;
   Relaxation; and
   Distraction.

The apparatus was programmed to run the “Butterfly game” which is described with reference to FIGS. 2 to 5 above. The programmed apparatus was thus used as a pre-treatment to a medical procedure (venepunture).

Due to medical ethics issues (injecting children) no formal control group could be subjected to injection without the procedure, but instead historical data was used as a control.

Each child from the study group was asked to complete a pain coping questionnaire and a face scale test. They were then introduced to the apparatus of the invention and instructed on its use (and that of the program displayed on the apparatus). Each child used the apparatus before entering the treatment room for venepuncture. The child's behavioural distress was scored during the procedure using observation scale of behavioural distress (OSBD). The child, parent and staff were interviewed to determine the levels of pain, distress and level of acceptance of the apparatus together with a further face scale test.

The procedural steps are set out below:

### The Pre-Treatment:

### Phase 1: The Child and Parents Wait Outside the Ward

The child and parents waited outside the ward until a nurse called them into the ward.

### Phase 2: Meeting and Greeting the Child and Parents

The nurse checked the medical records of the child to see if the child met the inclusion criteria of the research. If the child was suitable then the researcher introduced himself to the child and parents. The consent and assessment documents were signed if the parent and child were willing to participate.

### Phase 3: Pre-Assessment

The child then had Emla cream put onto his/her hand. A cover was then put on top of the Emla cream. Demographics & PCQ tests were then done with the child.

### Phase 4: The CA-CDT Intervention Procedure

The child was then prepared for the procedure room. The CA-CBT was explained to the child & parents in a room close to the procedure room. The researcher explained to the child how to use the computer and how to use the CA-CBT. The child then used the CA-CBT at their own pace. See FIG. 2 and previous description—the start screen from the “Butterfly game”. When the child finished the CA-CBT any comments from the child and parents were noted. The nurse then tested the effectiveness of the Ermla cream by touching the child's hand. The nurse then showed the child/parent into the treatment room.

### Commencement of Treatment

### Phase 5: Prepare the Child for the Venepuncture Procedure in the Treatment Room

The child and parents were then taken to the treatment room. The CA-CBT was then put away and the researcher prepared to measure the child's responses. The child or parent could choose a CBT technique they had learned from the CA-CBT to deal with the upcoming needle event. The child and parents sat down on the chairs and got ready for the procedure. The Pain Face scale test was then done with the child.

Phase 6: Venepuncture site preparation stage

The venepuncture site was then prepared by the nurse. The nurse tied a small torpine around the upper arm of the child. The event was used as an indicator to start the OSBD measurements. The nurse then looked for the veins. The child was then told not to move as the nurse used the child's arm to put the needle in.

### Phase 7: Needle Insertion Stage

The needle was put into the child's arm and the blood collected.

### Phase 8: Needle Removal and Plaster Stage

The needle was then removed and a plaster was put onto the child's hand. The torpine was then removed from the child's arm. This event was used as the indicator of the end of OSBD measurements. The Pain Face scale test was then taken again.

Phase 9: The Staff Might Give the Child a Reward for Dealing with the Procedure

### Phase 10: Recovery Period

The child and parents leave the treatment/procedure room. The researcher then asked the child and parents to do the questionnaire.

Pain intensity, procedural distress and copying style were determined as set out below,

### Measurements

### Pain Intensity

Pain Intensity was measured by child self report of pain using the Wong-Blaker Faces scale. This instrument uses a pictorial scale of five faces showing increased stages of pain (0=no pain, 1=mild pain, 2=moderate pain, 3=quite a lot of pain, 4=very bad pain, 5=worst pain), Prior to using the scale, the child received an explanation of what each face represents. The child was asked to point to the face that best represents his or her current level of pain. The scale is widely used in paediatric settings and has demonstrated validity for school age children during venepuncture.

### Procedural Distress

Procedural Distress was measured by Observational Scale of Behavioural Distress (OSBD). The OSBD rates 11 operational defined behaviours that indicate anxiety and or pain in children with weights to represent the intensity of the behaviour. The behavioural categories and the weights are: Cry (1.5), Scream (4.0), physical restraint (4.0), Verbal resistance (2.5), request emotional support (2.0), Muscular rigidity (2.5), Verbal fear (2.5), Verbal pain (2.5), Flail (4.0), Nervous behaviour (1.0), and information seeking (1.5). The observer will record the number of times behaviour is observed, then multiply that by the number weight of that category, and adds the products to obtain the total score. The child was evaluated at 15-second interval during the procedure, until return to baseline state. This scale has been validated for children age 3-12 years old undergoing a bone marrow aspiration.

### Coping Style

Coping Style was measured by the Pain Coping Questionnaire (Varni, J. W., Waldron, S. A., Gragg, R. A., et al., (1996). Development of the Waldron/Varni Pediatric Pain Coping Inventory. Pain. (67), pp. 141-150). This is a 39-item scale that identifies children's coping styles when dealing with painful situations. It has been validated in several large sample studies of healthy and ill American and Danish children, demonstrating good internal consistency, stability, and discriminate validity.

### Results

Sixteen children met the inclusion and were recruited for the CA-CBT study. One child's father declined, and three children did not have the reading level to complete the PCQ. One child did not complete the PCQ and was dropped from the study. The final sample consisted of eleven children who completed the CA-CBT protocol. All children were seen in the Dickens investigation unit for GFR tests.

The characteristic of the children are shown in Table 1 and Table 2 below.

TABLE 1
Demographic characteristics

| | | | | | | | Total |
|---|---|---|---|---|---|---|---|
| | | | | | | | time for |
| | Age | | | | Coping | Pain | OSBD |
| Id | (Years) | Sex | Reason for GFR | Last needle | Style | Intensity | (Minutes) |
| A | 10 | M | Ante natal diagnosis bilateral | 25 Jun. 1999 | A = 2.21 | Before: 0 | 3 |
| | | | hydronephrosis, poilated | One a year | D = 3.3 | After: 0 | |
| | | | VUR (Vesico-Uretenc | | E = 2.2 | | |
| | | | Reflex) | | | | |
| | | | R+, Renal dysplasia | | | | |
| B | 8.5 | M | Serier Fabry's disease. | None for a | A = 3.05 | Before: 2 | 4 |
| | | | | year | D = 2.7 | After: 1 | |
| | | | | | E = 3 | | |
| C | 7 | M | PUV (post urethral valves) | None for | A = 2.37 | Before: 0 | 5.25 |
| | | | VUR. | 18 months | D = 1.4 | After: 2 | |
| | | | | | E = 4 | | |
| D | 10 | M | Malignant hypertension | None for 1 | A = 3.15 | Before: 1 | 4.25 |
| | | | | year | D = 2.6 | After: 1 | |
| | | | | | E = 2 | | |
| E | 8 | F | Ante-natal diagnosis of | None for 1 | A = 3 | Before: 0 | 3.75 |
| | | | pelvicalceal dilatation | year | D = 3.3 | After: 2 | |
| | | | | | E = 1.8 | | |
| F | 8 | M | Left vesicoureteric reflux | Last one a | A = 3.90 | Before: 0 | 3.75 |
| | | | Neuropathic bladder + | year ago | D = 3.9 | After: 0 | |
| | | | recurrent urinary tract | | E = 2.8 | | |
| | | | infection | | | | |
| G | 6 | F | Hydronephrosis, Multicystic | Every day | A = 2.42 | Before: 1 | 3 |
| | | | kidney | needle for | D = 3.7 | After: 1 | |
| | | | | Growth | E = 1.7 | | |
| | | | | Hormone | | | |
| H | 7 | M | Hypoplastic urinary tract | | A = 2.42 | Before: 0 | 4.5 |
| | | | | | D = 3.7 | After: 0 | |
| | | | | | E = 1.7 | | |
| I | 9 | F | Cystinosis | Last needle | A = 2.10 | Before: 1 | 3.25 |
| | | | | event in | D = 3.3 | After: 1 | |
| | | | | October | E = 2 | | |
| J | 7 | M | Dermatomyositis | Last blood | A = 2.95 | Before: 0 | 2.5 |
| | | | | test | D = 2.7 | After: 3 | |
| | | | | 10 Nov. 2000. | E = 1.5 | | |
| | | | | Has one | | | |
| | | | | every | | | |
| | | | | month. | | | |
| K | 9 | F | Recurrent Urinary Tract | 12 Jun. 2000 for | A = 3.06 | Before: 0 | 3.25 |
| | | | Infection. | blood test. | D = 2.6 | After: 2 | |
| | | | | | E = 3.1 | | |

Note:
For PCQ test: A = Approach, D = Distraction, E = Emotional focused avoidance

TABLE 2
Descriptive Statistics. Means and standard
deviation (SD) (N = 11).

| | Minimum | Maximum | Mean | SD. |
|---|---|---|---|---|
| AGE | 6.00 | 10.00 | 8.1364 | 1.3056 |
| LASTVP | .03 | 18.00 | 8.0055 | 6.5501 |
| TOTIME | 2.25 | 5.25 | 3.6591 | .8312 |
| PREFACES | .00 | 2.00 | .4545 | .6876 |
| POSTFACE | .00 | 3.00 | 1.1818 | .9816 |
| PTOSBD | .00 | 1.80 | .1636 | .5427 |
| PREVPOSB | .00 | 7.30 | 2.4773 | 2.7186 |
| VPOSBD | .00 | 8.30 | 2.1523 | 2.9677 |
| POSTOSBD | .00 | 1.50 | .2091 | .4908 |
| TOTAL | .00 | 17.02 | 4.8210 | 5.4786 |
| IS | 1.50 | 4.00 | 2.9318 | .8810 |
| PS | .84 | 3.50 | 2.1164 | .8755 |
| SSS | 1.20 | 4.40 | 2.8727 | 1.2142 |
| PSE | 1.80 | 3.60 | 2.7273 | .5605 |
| BD | 1.00 | 4.00 | 2.7636 | .9373 |
| CD | 1.80 | 3.80 | 3.0909 | .5822 |
| EX | 1.20 | 3.80 | 2.1818 | .8920 |
| INT | 1.40 | 4.20 | 2.4727 | .8912 |
| A | 1.74 | 3.89 | 2.7225 | .6116 |
| D | 1.40 | 3.90 | 2.9273 | .6828 |
| E | 1.50 | 4.00 | 2.3273 | .7964 |

Key for Table 2
ID = identity
AGE = chronological age in years.
SEX = gender. N = 0 is equal to male. N = 1 is equal to female.
LASTVPL = last time had venepuncture procedure.
TOTIME = total time in minutes of the venepuncture procedure.
PREFACE = face scale before venepuncture procedure.
POSTFACE = face scale after venepuncture procedure.
PTOSBD (T1) = Baseline OSBD
PREVPOSB (T2) = before venepuncture procedure (e.g. the time from the band going on the arm to the time the needle went in).
VPOSBD (T3) = during venepuncture procedure (e.g. the time from the needle in the arm till the needle came out of the arm).
POSTOSBD (T4) = time after venepuncture procedure (e.g. the time from after the band has been removed).
TOTAL = total distress.
IS = information seeking
PS = Problem solving
SSS = Seeking social support
PSE = Positive self-statement
BD = Behavioural distraction
CD = Cognitive distraction
EX = Externalisation
INT = Internalising/catastrophizing
A = Approach
D = Distraction
E = Emotional focused approach.

The GFR tests were performed for the indications listed in Table 1. The last time a child had a venepuncture procedure ranged from the previous day, for a child who was having a growth hormone, to one year, for a child who had a blood sample.

The CA-CBT training lasted 15 to 35 minutes, depending on the child's reading level. The children's parents were present during the CA-CBT training and the venepuncture procedure.

The venepuncture procedure total time (TOTIME) was measured from the time when the band was placed around the child's arm to the time the plaster was placed on the venepuncture site. The total procedure time ranged from 2.25 to 5.25 minutes, the mean was 3.66 minutes and the standard deviation was 0.83 minutes.

The scores for each child for the three major coping styles measured by the PCQ (approach, distraction, and emotion-focused avoidance) are shown in Table 1. Using student's t-tests, there were no significant differences in the mean values for the three subtypes, indicating that children used similar levels of all three coping styles (t=0.85-1.54, df 10, p=0.42-0.16).

Paired student's t tests were used to compare the pain intensity scores and the distress scores between the phases of the procedure. The results are shown in Table 3 below

TABLE 3

| | | | Sig. |
|---|---|---|---|
| Pair | T | df | (2-tailed) |
| Pair 1 PREFACES-POSTFACE | −1.896 | 10 | 0.87 |
| Pair 2 PREVPOSB (T2)-VPOSBD (T3) | .443 | 10 | 0.667 |
| Pair 3 PREVPOSB (T2)-POSTOSBD (T4) | 3.086 | 10 | 0.012 |
| Pair 4 PTOSBD (T1)-POSTOSBD (T4) | −.567 | 10 | 0.583 |
| Pair 5 PTOSBD (T1)-VPOSBD (T3) | −2.513 | 10 | .031 |

Pair 1: There was no difference in the mean pain intensity scores before (T1) and after the procedure (T5).
Pair 2: There was no difference for pre-procedure level (T2) of behavioural distress during the venepuncture (T3).
Pair 3: There was less behavioural distress after the venepuncture (T4) then pre-procedure (T2) but not at baseline levels (T1).
Pair 4: No difference of distress for post procedure (T4) and baseline (T1).
Pair 5: Shows baseline (T1) was less compared to during the venepuncture (T3)

The OSBD scores for each phase of the procedure are presented in Table 4.

TABLE 4

| | Pre test | Post test OSBD | Before venepuncture | Venepuncture | |
|---|---|---|---|---|---|
| | OSBD | (Recovery) | procedure OSBD | procedure OSBD | Total |
| Study | “PTOSBD” | “POSTOSB” | “PREVPOSB” | “VPOSBD” | OSBD |
| A | 0 | 0 | 1.75 | 1.13 | 2.875 |
| B | 0 | 0.8 | 4 | 26.2 | 6.92 |
| C | 1.8 | 1.5 | 7.3 | 8.3 | 17.02 |
| D | 0 | 0 | 0 | 0 | 0 |
| E | 0 | 0 | 0 | 0.75 | 0.75 |
| F | 0 | 0 | 3.4 | 6.7 | 10.1 |
| G | 0 | 0 | 3.7 | 4.3 | 7.97 |
| H | 0 | 0 | 0 | 0.3 | 0.3 |
| I | 0 | 0 | 6.6 | 0 | 6.6 |
| J | 0 | 0 | 0.5 | 0 | 0.5 |
| K | 0 | 0 | 0 | 0 | 0 |

The children who had the most distress (Table 4) were subject B, C, F, G, and I. These were the same children who had a higher distress before the venepuncture procedure. These children were also younger than the other children in the group,

### Discussion of Results

The research compared the pre to post distress and pain intensity to find an indicator of the effect of the CA-CBT. From the literature (Rodin, 3+(1983). “Will this hurt? Preparing children for hospital and medical Procedures.” Royal College of Nursing. London) both distress and pain should increase during (T2) and after (T4) compared to base levels (T1). Therefore the findings that there was no significant difference before T2 and during the procedure T3 for the children using the apparatus suggest it is effective in reducing pain and distress.

As such, in a medical environment, the indication is that getting children to undertake a pre-procedural training using the apparatus would improve patient quality (reduced pain and distress) and also improve compliance. This improved compliance could save medical practitioner's time and health services and insurance provider's money

Whilst the benefits of the apparatus and its use have been demonstrated to be effective with reference to a venepuncture procedure the principals embodied could be applied to other medical procedures, such as for example, the treatment of conditions such as, for example:
diabetes,
asthma
attention deficit disorders
pain management for palliative care

The reader will appreciate that the example given is illustrative and the principles embodied can be applied to other events and procedures.

1. An apparatus, for training a user to develop coping-skills which may facilitate improved compliance to an event by the user, comprising:
a screen for displaying information relating to the event to the user;
a user interface, enabling the user to operate a program which demonstrates the coping-skills to the user in the context of the event, wherein the apparatus is programmed to display a plurality of visually different characters that can be observed and interacted with by the user,
each character being unique and programmed to exclusively perform an act or acts that will teach the user a specific coping skill to the exclusion of a different coping skill, whereby through use, the user is conditioned to relate a particular coping skill taught by a given character to that character such that in an event situation the user can be prompted to perform a specific coping skill by reference to the actions of an individual character (i.e. the character act as a mnemonic for the coping skill being taught by the actions of the character).

2-21. (canceled)
